(19) United States
(12) Patent Application Publication
(10) Pub. No.: US 2016/0040775 A1
(43) Pub. Date: Feb. 11, 2016

(54) Electric Oil Pump for Automatic Transmission

(71) Applicant: Hyundai Motor Company, Seoul (KR)

(72) Inventor: Jinyoung HWANG, Busan (KR)

(73) Assignee: Hyundai Motor Company, Seoul (KR)

(21) Appl. No.: 14/555,098

(22) Filed: Nov. 26, 2014

(30) Foreign Application Priority Data
Aug. 7, 2014 (KR) 10-2014-0101512

(51) Int. Cl. F16H 57/04; F16H 61/00

(52) U.S. Cl. CPC F16H 57/0439; F16H 61/0031; F16H 57/0413

(57) ABSTRACT

An electric oil pump for an automatic transmission may include a case in which a first space and a second space partitioned from each other are formed at one side and another side respectively, and a cooling water chamber in which cooling water is circulated and an oil chamber in which automatic transmission fluid (ATF) is circulated are formed on outer circumferences of the first and second spaces, respectively, a motor part including a stator fixed to the case and a rotor installed on a drive shaft, in the first space, a control part configured by a circuit board in the second space to control driving of the motor part, and a pump part configured at a front side of the case to receive power of the drive shaft and pump the automatic transmission fluid (ATF).

### CROSS-REFERENCE TO RELATED APPLICATION

The present application claims priority to Korean Patent Application No. 10-2014-0101512 filed Aug. 7, 2014, the entire contents of which is incorporated herein for all purposes by this reference.

### BACKGROUND OF THE INVENTION

1. Field of the Invention

The present invention relates to an electric oil pump for an automatic transmission, and more particularly, to an electric oil pump for an automatic transmission that integrates and configures a motor part and a control part in a case of an oil pump and simultaneously functions as an oil warmer for an automatic transmission by using the case.

2. Description of Related Art

In recent years, as higher oil prices worldwide and exhaust gas discharge regulations have gotten more restrictive, car makers have devoted all their power to technological development which is environmentally friendly and can improve fuel efficiency.

In particular, enhancement of the fuel efficiency in an automatic transmission can be implemented by minimizing unnecessary consumption power of an oil pump.

In general, the oil pump of the automatic transmission adopts a mechanical oil pump that operates in connection with a drive shaft of an engine and the mechanical oil pump has a problem in that power loss occurs by supplying supernumerary oil in a high RPM region of the engine because independent RPM control is impossible, and a discharge flow required at high-temperature lowest RPM needs to be formed, and as a result, a larger capacity than a required flow in a commercial field has been designed.

Further, the oil pump of the automatic transmission is disadvantageous in that a separate electric oil pump should be additionally mounted in order to apply an idle stop & go (ISG) system that stops the engine during stopping.

In order to enhance the disadvantage, a scheme for minimizing power loss by controlling RPM of the pump according to a required flow by applying the electric oil pump has been promoted in recent years.

That is, the oil pump applied to the automatic transmission is separated into a low-pressure oil pump and a high-pressure oil pump to supply oil pressure generated by the low-pressure oil pump to a low-pressure unit (a torque converter, cooling, and lubrication) and supply oil pressure generated by the high-pressure oil pump to a high-pressure unit (friction members including a clutch, a brake, and the like, which are selectively actuated during transmission).

The automatic transmission having two oil pumps as described above is configured to generate overall oil pressure based on the low-pressure unit and simultaneously boot only a part of the oil pressure to high pressure required in the high-pressure unit and supply the boosted oil pressure.

As described above, there is a method for minimizing a waste of power by using the electric oil pump in parallel with the mechanical oil pump or supplying oil to the transmission only by using the electric oil pump as the low-pressure oil pump and the high-pressure oil pump are separated and configured, and it is anticipated that the electric oil pump will be basically mounted on the automatic transmission afterwards.

However, in the electric oil pump, heat emission of the motor part and the control part of the electric oil pump comes to the fore as a use weight such as a driving load or a driving time increases, and the present invention intends to propose a method for enhancing the heat emission problem of the electric oil pump and reusing generated heat.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an electric oil pump for an automatic transmission that reduces an overall length of the oil pump by integrally configuring a motor part and a control part in a case of the oil pump and enables weight reduction and cost saving by deleting wiring with the control part.

Additionally, various aspects of the present invention are directed to providing an electric oil pump for an automatic transmission that induces heat exchange between automatic transmission fluid (ATF) and cooling water by simultaneously forming an oil chamber connected with an oil circulation path and a cooling water chamber connected with a cooling water path in the case of the oil pump, thereby simultaneously functioning as an oil warmer for the automatic transmission.

According to various aspects of the present invention, an electric oil pump for an automatic transmission may include a case in which a first space and a second space partitioned from each other are formed at one side and another side respectively, and a cooling water chamber in which cooling water is circulated and an oil chamber in which automatic transmission fluid (ATF) is circulated are formed on outer circumferences of the first and second spaces, respectively, a motor part including a stator fixed to the case and a rotor installed on a drive shaft, in the first space, a control part configured by a circuit board in the second space to control driving of the motor part, and a pump part configured at a front side of the case to receive power of the drive shaft and pump the automatic transmission fluid (ATF).

The oil chamber may be formed outside the cooling water chamber.

The oil chamber may be connected with an oil circulation path at both sides so as to suck and discharge the automatic transmission fluid (ATF).

The cooling water chamber may be connected with a cooling water circulation path at both sides so as to suck and discharge the cooling water.

The automatic transmission fluid (ATF) in the oil chamber and the cooling water in the cooling water chamber may be configured to exchange heat by heat transfer via the case.

The pump part may be configured to suck the automatic transmission fluid (ATF) from an oil storage of the automatic transmission by integrally forming a sucking path and a discharge path in a pump housing formed at the front side of the case to discharge the sucked automatic transmission fluid (ATF) to the automatic transmission.

According to various aspects of the present invention, an electric oil pump for an automatic transmission may include a first space in which a motor part is installed and a second space in which a control part is installed, the first and second spaces being partitioned from each other to be adjacent to each other in a case, a cooling water chamber in which engine cooling water is circulated and an oil chamber in which an automatic transmission fluid (ATF) is circulated formed on outer circumferences of the first and second spaces, respectively, and a pump part, which receives power of the motor part to pump the automatic transmission fluid (ATF) integrally configured at a front side of the case.

The oil chamber may be formed outside the cooling water chamber.

The case of the electric oil pump may be connected with an oil circulation path at both sides of the oil chamber so as to suck and discharge the automatic transmission fluid (ATF) in and from the oil chamber, and may be connected with a cooling water circulation path on an engine cooling system so as to suck and discharge engine cooling water in and from the cooling water chamber.

The automatic transmission fluid (ATF) in the oil chamber and the cooling water in the cooling water chamber may be configured to exchange heat by heat transfer via the case.

The motor part may include a stator fixed to the case and a rotor installed on a drive shaft, in the first space.

The control part may be configured by a circuit board in the second space to control driving of the motor part.

The pump part may be configured to suck the automatic transmission fluid (ATF) from an oil storage of the automatic transmission by integrally forming a sucking path and a discharge path in a pump housing formed at the front side of the case to discharge the sucked automatic transmission fluid (ATF) to the automatic transmission.

According to various aspects of the present invention, it is possible to reduce an overall length of the oil pump by integrally configuring a motor unit and a control unit in a case of the oil pump and enable weight reduction and cost saving by deleting wiring with the control unit.

It is possible to induce heat exchange by heat transfer is induced between automatic transmission fluid (ATF) and cooling water by simultaneously forming an oil chamber connected with an oil circulation path so as to circulate the automatic transmission fluid (ATF) and a cooling water chamber connected with a cooling water circulation path so as to circulate the cooling water in the case of the oil pump so as to simultaneously function as an oil warmer for the automatic transmission, thereby reducing the number of components to improve mountability.

That is, when an engine is cold, it is possible to improve warm-up performance of the automatic transmission fluid (ATF) by using heat energy generated from a motor part and a control part and to serve to improve fuel efficiency performance of a transmission, and when the engine is warm, it is possible to serve to cool the motor part and the control part through cooling water cooled by a radiator, thereby enabling driving over a long-time of the electric oil pump.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of an exemplary electric oil pump for an automatic transmission according to the present invention.

FIG. 2 is an operation circuit diagram when an engine is cooled by an engine cooling system adopting the exemplary electric oil pump for the automatic transmission according to the present invention.

FIG. 3 is an operation circuit diagram when the engine is warmed by the engine cooling system adopting the exemplary electric oil pump for the automatic transmission according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

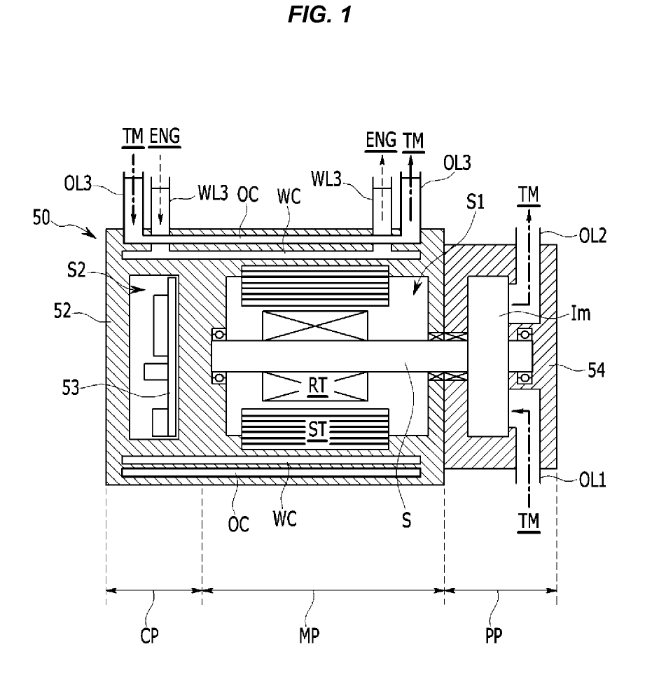

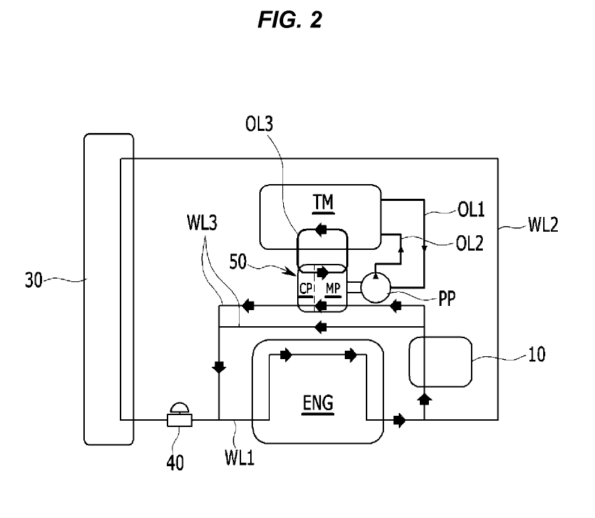

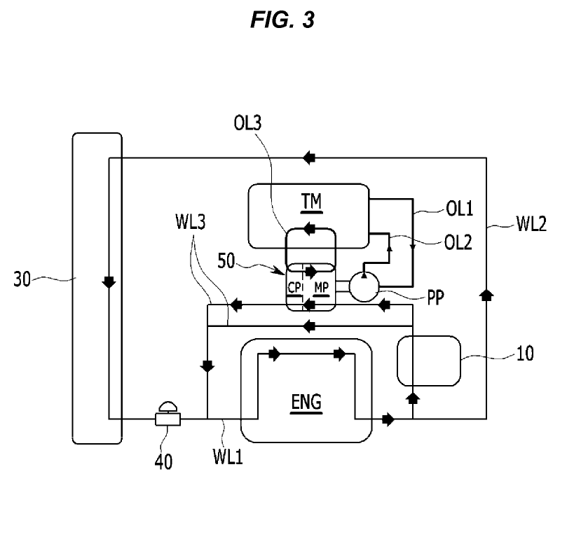

FIG. 1 is a cross-sectional view of an electric oil pump for an automatic transmission according to various embodiments of the present invention. FIG. 2 is an operation circuit diagram when an engine is cooled by an engine cooling system adopting the electric oil pump for an automatic transmission according to various embodiments of the present invention. FIG. 3 is an operation circuit diagram when the engine is warmed by the engine cooling system adopting the electric oil pump for an automatic transmission according to various embodiments of the present invention.

Referring to FIG. 1, the electric oil pump 50 for an automatic transmission according to various embodiments of the present invention includes a case 52, a motor part MP, a control part CP, and a pump part PP.

In the case 52, a first space Si is formed at the pump part PP side, a second space S2 is formed at an opposite side to the pump part PP, and the first space S1 and the second space S2 are partitioned from each other.

Further, a cooling water chamber WC in which cooling water is circulated and an oil chamber OC in which an automatic transmission fluid (ATF) is circulated are formed on the outer circumferences of the first and second spaces S1 and S2, respectively, in the case 52.

In this case, an example in which the oil chamber OC is formed outside the cooling water chamber WC is applied to various embodiments of the present invention, but vice versa.

Herein, the oil chamber OC is connected with an oil circulation path OL3 at both sides so as to suck and discharge the automatic transmission fluid (ATF), and the automatic transmission fluid (ATF) is sucked at one side and the automatic transmission fluid (ATF) is discharged at the other side.

Further, the cooling water chamber WC is also connected with a cooling water circulation path WL3 at both sides so as to suck and discharge the cooling water, and the cooling water is sucked at one side and the cooling water is discharged at the other side.

In this case, the automatic transmission fluid (ATF) in the oil chamber OC and the cooling water in the cooling water chamber WC are configured to exchange heat by heat transfer via the case 52.

Meanwhile, the motor part MP includes a stator ST fixed to the case 52 and a rotor RT installed on a drive shaft S, in the first space S1, and is driven according to a control signal from the control part CP.

In addition, the control part CP is configured by a circuit board 53 in the second space S2 and outputs the control signal to the motor part MP to control driving of the motor part MP.

Further, the pump part PP is configured to be disposed at a front side of the case 52 and pump the automatic transmission fluid (ATF) by receiving rotational power of the drive shaft S, and in the pump part PP, a pump housing 54 is integrally fixed to the front side of the case 52, and a sucking path OL1 and a discharge path OL2 are formed in the pump housing 54.

The pump part PP is actuated to suck the automatic transmission fluid (ATF) from an oil storage of the automatic transmission TM through the sucking path OL1 to discharge the sucked automatic transmission fluid (ATF) to the automatic transmission TM through the discharge path OL2 when an impeller Im in the pump housing 54 rotates by using the rotational power of the motor part MP.

Hereinafter, an operation of the electric oil pump 50 for an automatic transmission according to various embodiments of the present invention which is connected with an engine cooling system when an engine ENG is cold and warm will be described with reference to FIGS. 2 and 3.

First, referring to FIG. 2, the electric oil pump 50 for an automatic transmission according to various embodiments of the present invention is connected with the cooling water circulation path WL3 of the engine cooling system and the oil circulation path OL3 of the automatic transmission TM to function as the existing oil warmer.

Herein, the engine cooling system is basically configured so that cooling water cooled by a radiator 30 is supplied to the engine ENG through a first cooling water path WL1 and cooling water warmed from the engine ENG is supplied again to the radiator 30 through a second cooling water path WL2.

Further, the engine cooling system is configured in such a manner that the cooling water circulation path WL3, which connects the first and second cooling water paths WL1 and WL2 at sucking and discharge sides based on the engine ENG, to bypass the cooling water.

In addition, a thermostat 40 is configured on the first cooling water path W1 and a vehicular heater heat exchanger 10 is configured on the cooling water circulation path WL3.

In the engine cooling system, the electric oil pump 50 for an automatic transmission according to various embodiments of the present invention is positioned on the cooling water circulation path WL3 to circulate the cooling water in the cooling water chamber WC inside the case 52.

Further, the electric oil pump 50 for an automatic transmission according to various embodiments of the present invention is connected with the oil circulation path OL3 of the automatic transmission TM so as to circulate the automatic transmission fluid (ATF) in the oil chamber OC inside the case 52.

That is, as described above, in the electric oil pump for an automatic transmission according to various embodiments of the present invention, while the oil chamber in the case is connected with the oil circulation path at both sides so as to suck and discharge the automatic transmission fluid (ATF) and the cooling water chamber is connected with the cooling water circulation path WL3 at both sides so as to suck and discharge the cooling water, the automatic transmission fluid (ATF) in the oil chamber and the cooling water in the cooling water chamber are configured to exchange heat by heat transfer via the case to simultaneously function as the oil warmer.

Hereinafter, the function of the oil warmer by the electric oil pump 50 for an automatic transmission according to various embodiments of the present invention will be described with reference to FIG. 2 and FIG. 3.

Referring to FIG. 2, like an initial start, when the engine ENG is cold, the thermostat 40 is turned off, and as a result, the cooling water of the radiator 30 is interrupted from flowing to the engine ENG, and the cooling water warmed by the engine ENG does not pass through the radiator 30, and as a result, an increase in the temperature of the cooling water is accelerated.

In this case, the cooling water and the automatic transmission fluid (ATF) exchange heat while flowing to the cooling water chamber WC and the oil chamber OC, which are formed in the case 52 of the electric oil pump 50, respectively, so as to rapidly increase the temperature of the automatic transmission fluid (ATF), and in this case, heat amounts generated from the motor part MP and the control part CP are also reused as a heat source that heats the automatic transmission fluid (ATF) and the cooling water to serve to more rapidly increase the temperature of the automatic transmission fluid (ATF), thereby improving transfer efficiency of the automatic transmission TM.

Meanwhile, on the contrary, when the engine ENG is warm, the thermostat 40 is turned on, and as a result, the cooling water flows to the radiator 30 and the cooling water warmed by the engine ENG passes through the radiator 30 to serve to cool the engine ENG and the automatic transmission fluid (ATF).

That is, the cooling water cooled by the radiator 30 serves to cool the motor part MP and the control part CP, which are heating sources, in addition to cooling the automatic transmission fluid (ATF) by heat exchange through the cooling water chamber WC in the case 52 of the electric oil pump 50.

As described above, in the electric oil pump 50 for an automatic transmission according to various embodiments of the present invention, the motor part MP and the control part CP are integrally configured in the case 52 to reduce the overall length of the oil pump 50, and wiring of the control part CP is thus deleted, and as a result, it is advantageous in weight reduction and cost saving.

The heat exchange by the heat transfer is induced between the automatic transmission fluid (ATF) and the cooling water by simultaneously forming the oil chamber OC and the cooling water chamber WC in the case 52 to simultaneously function as the oil warmer for the automatic transmission, thereby reducing the number of components to improve mountability.

In particular, when the engine is cold, fuel efficiency performance of the automatic transmission TM may be improved by improving warm-up performance of the automatic transmission fluid (ATF) by using heat energy of the motor part MP and the control part CP, which are the heating source, and when the engine is warm, the motor part MP and the control part CP are cooled through the cooling water cooled by the radiator 30 to secure driving over a long time of the oil pump 50.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An electric oil pump for an automatic transmission, comprising:
a case in which a first space and a second space partitioned from each other are formed at one side and another side respectively, and a cooling water chamber in which cooling water is circulated and an oil chamber in which automatic transmission fluid (ATF) is circulated are formed on outer circumferences of the first and second spaces, respectively;
a motor part including a stator fixed to the case and a rotor installed on a drive shaft, in the first space;
a control part configured by a circuit board in the second space to control driving of the motor part; and
a pump part configured at a front side of the case to receive power of the drive shaft and pump the automatic transmission fluid (ATF).

2. The electric oil pump of claim 1, wherein the oil chamber is formed outside the cooling water chamber.

3. The electric oil pump of claim 2, wherein the oil chamber is connected with an oil circulation path at both sides so as to suck and discharge the automatic transmission fluid (ATF).

4. The electric oil pump of claim 2, wherein the cooling water chamber is connected with a cooling water circulation path at both sides so as to suck and discharge the cooling water.

5. The electric oil pump of claim 2, wherein the automatic transmission fluid (ATF) in the oil chamber and the cooling water in the cooling water chamber are configured to exchange heat by heat transfer via the case.

6. The electric oil pump of claim 1, wherein the pump part is configured to suck the automatic transmission fluid (ATF) from an oil storage of the automatic transmission by integrally forming a sucking path and a discharge path in a pump housing formed at the front side of the case to discharge the sucked automatic transmission fluid (ATF) to the automatic transmission.

7. An electric oil pump for an automatic transmission, comprising:
a first space in which a motor part is installed and a second space in which a control part is installed, the first and second spaces being partitioned from each other to be adjacent to each other in a case;
a cooling water chamber in which engine cooling water is circulated and an oil chamber in which an automatic transmission fluid (ATF) is circulated formed on outer circumferences of the first and second spaces, respectively; and
a pump part, which receives power of the motor part to pump the automatic transmission fluid (ATF) integrally configured at a front side of the case.

8. The electric oil pump of claim 7, wherein the oil chamber is formed outside the cooling water chamber.

9. The electric oil pump of claim 8, wherein the case of the electric oil pump is connected with an oil circulation path at both sides of the oil chamber so as to suck and discharge the automatic transmission fluid (ATF) in and from the oil chamber, and connected with a cooling water circulation path on an engine cooling system so as to suck and discharge engine cooling water in and from the cooling water chamber.

10. The electric oil pump of claim 8, wherein the automatic transmission fluid (ATF) in the oil chamber and the cooling water in the cooling water chamber are configured to exchange heat by heat transfer via the case.

11. The electric oil pump of claim 7, wherein the motor part includes a stator fixed to the case and a rotor installed on a drive shaft, in the first space.

12. The electric oil pump of claim 7, wherein the control part is configured by a circuit board in the second space to control driving of the motor part.

13. The electric oil pump of claim 7, wherein the pump part is configured to suck the automatic transmission fluid (ATF) from an oil storage of the automatic transmission by integrally forming a sucking path and a discharge path in a pump housing formed at the front side of the case to discharge the sucked automatic transmission fluid (ATF) to the automatic transmission.
